(19) United States
(12) Patent Application Publication
(10) Pub. No.: US 2011/0188230 A1
(43) Pub. Date: Aug. 4, 2011

(54) OPTICAL SHEET AND COMPOSITE SHEET WITH MOIRE FRINGE, AND BACKLIGHT ASSEMBLY HAVING THE SAME

(75) Inventors: Hyo Jin Lee, Gyeonggi-do (KR); Jung Whan Yoon, Chungcheongbuk-do (KR); Bong Jae Lee, Chungcheongnam-do (KR); Kang Shik Lee, Gyeonggi-do (KR); Yong Kwon Cho, Daegu Metropolitan City (KR); Hee Eun Jang, Daegu Metropolitan City (KR); Hyo Goo Jeon, Chungcheongbuk-do (KR)

(73) Assignee: MIRAENANOTECH CO., LTD., Chungcheongbuk-do (KR)

(21) Appl. No.: 13/062,933

(22) PCT Filed: Sep. 8, 2009
(86) PCT No.: PCT/KR09/05082

§ 371 Date: Apr. 8, 2011

(30) Foreign Application Priority Data
Sep. 8, 2008 (KR) 10-2008-0088484

(51) Int. Cl. G02F 1/13357; B32B 3/00

(52) U.S. Cl. 362/97.1; 428/141

(57) ABSTRACT

The present invention relates to an optical sheet and a composite sheet with a moire fringe and a backlight assembly having the same. The present invention provides an optical sheet including: a first pattern layer on which a first pattern array is formed and a second pattern layer on which a second pattern array generating a moire fringe by overlapping with the first pattern array is formed. With the present invention, it can expand a viewing angle while improving luminance. In addition, the number of LED light sources mounted on the backlight assembly is reduced, making it possible to reduce production costs.

### TECHNICAL FIELD

The present invention relates to an optical sheet and a composite sheet and a backlight assembly having the same. More specifically, the present invention relates to an optical sheet and a composite sheet with a moire fringe and a backlight assembly having the same.

### BACKGROUND ART

Generally, a liquid crystal display (LCD) is a device that displays figures and images by injecting liquid crystals, which is an intermediate state of a liquid material and a solid material, between two glass substrates formed of electrodes and applying electric field to the liquid crystals. Since the liquid crystal display is not a self-luminescent device, it includes a backlight unit (BLU) as a light source that generates light. The liquid crystal display displays images while controlling transmittance of light generated from the backlight unit in a panel unit where liquid crystals are uniformly aligned.

The liquid crystal display can be classified into a twisted nematic (TN) type, an in-plane switching (IPS) type, a vertical align (VA) type, etc., according to an alignment type of liquid crystals. Among these, the TN type and the IPS type are excellent in transmittance of light as compared to the VA type and therefore, are suitable for a place where front visibility is needed but have a very poor viewing angle. On the other hand, the VA type has an excellent viewing angle as compared to the TN type or the IPS type, but has low transmittance of light and therefore, degrades luminance.

In the related art, in order to improve either of the luminance and the viewing angle, as an optical film mounted on a backlight unit, a diffusion sheet, a brightness enhancement film (BEF), a dual brightness enhancement film (DBEF), and a diffusive reflective polarization film (DRPF) were used. However, the use of the optical film increases the entire thickness of the backlight unit, such that it is difficult to make the liquid crystal display slim. In addition, it increases production costs, which degrades degrade product competitiveness. Further, although the optical film is applied to the liquid crystal display, it is impossible to improve both the luminance and the viewing angle at the same time, otherwise one is only improved.

### DISCLOSURE OF INVENTION

### Technical Problem

The present invention proposes to solve the above problems. It is an object of the present invention to provide an optical sheet and a composite sheet with a moire fringe and a backlight assembly having the same.

### Technical Solution

The present invention proposes to solve the above problems. There is provided an optical sheet including: a first pattern layer on which a first pattern array is formed and a second pattern layer on which a second pattern array generating a moire fringe by overlapping with the first pattern array is formed.

In addition, the present invention provides an optical sheet that includes a pattern layer having the first pattern array formed on one surface thereof and the second pattern array, which generates the moire fringe by overlapping with the first pattern array, formed on the other surface thereof.

Further, there is provided a composite sheet including: a first optical sheet on which a first pattern array is formed and a second optical sheet on which a second pattern array generating a moire fringe by overlapping with the first pattern array is formed.

In addition, the present invention provides a backlight assembly including: any one sheet of an optical sheet that includes a first pattern layer on which a first pattern array is formed and a second pattern layer on which a second pattern array generating a moire fringe by overlapping with the first pattern array is formed, an optical sheet that includes a pattern layer having the first pattern array formed on one surface thereof and the second pattern array, which generates the moire fringe by overlapping with the first pattern array, formed on the other surface thereof, and a composite sheet that includes a first optical sheet on which the first pattern array is formed and a second optical sheet on which the second pattern array generating the moire fringe by overlapping with the first pattern array is formed; and a light source unit that generates light and irradiates the generated light as incident light to the optical sheet.

### Advantageous Effects

With the present invention, it uses the optical sheet with a moire fringe, thereby making it possible to obtain the following effects. First, it patterns the moire fringe, thereby making it possible to increase the luminance and expand the viewing angle. Second, it uses the integrated phenomenon of the patterns for clearly displaying the moire fringe, thereby making it possible to remarkably reduce the number of LED light sources mounted on the backlight assembly and reduce the production costs. Third, it can apply the sheet with a moire fringe to the optical film, thereby making it possible to make the thickness of the optical film thin and to contribute to the slimness of the display such as an LCD.

### BRIEF DESCRIPTION OF DRAWINGS

FIG. 1 is a cross-sectional view of an optical sheet with a moire fringe according to a preferred embodiment of the present invention;

FIG. 2 is a reference diagram for explaining a process of forming the moire fringe of the moire sheet;

FIGS. 3 and 4 are reference diagrams for explaining pattern forms of each pattern layer that is provided on the moire sheet;

FIG. 5 shows an actual implementation example of a pattern layer including an intaglio pattern array or an engraving pattern array;

FIG. 6 is an exemplified diagram showing a pattern shape formed on the pattern layer;

FIG. 7 is a flow chart for explaining a method for producing a moire sheet according to an exemplary embodiment of the present invention;

FIG. 8 is a flow chart for explaining a method for producing a moire sheet according to another exemplary embodiment of the present invention;

FIG. 9 is a conceptual diagram schematically showing a backlight assembly according to the exemplary embodiment of the present invention;

FIG. 10 is a comparative graph of luminance values for each optical sheet;

FIG. 11 is a comparative graph of viewing angles for each optical sheet;

FIG. 12 is a reference diagram for explaining a change in a size of a moire pattern according to a tilt value;

FIGS. 13 to 15 each is a diagram showing the change in the size of the moire pattern according to the tilt value when the pattern shape is a regular triangle, a regular hexagon, a regular square, and a regular pentagon; and

FIG. 16 is a diagram showing the change in the size of the moire pattern according to the tilt value when the pattern shape is a circle.

### BEST MODE FOR CARRYING OUT THE INVENTION

The present invention proposes to solve the above problems. There is provided an optical sheet including: a first pattern layer on which a first pattern array is formed and a second pattern layer on which a second pattern array generating a moire fringe by overlapping with the first pattern array is formed.

Preferably, a first direction angle that one-dimensionally or two-dimensionally expresses an aligned direction of patterns forming the first pattern array and a second direction angle that one-dimensionally or two-dimensionally expresses an aligned direction of patterns forming the second pattern array are different from each other. More preferably, a difference between the first direction angle and the second direction angle exceeds 0° and is less than 90°.

Preferably, the first pattern array or the second pattern array is a set of patterns regularly aligned at each predetermined interval and the second pattern array includes at least one pattern that completely overlaps with one pattern of the first pattern array and at least one pattern that partly overlaps with one pattern of the first pattern array.

Preferably, the first pattern array includes the same number of patterns or a larger number of patterns as compared to the second pattern array. More preferably, the patterns included in the first pattern array or the second pattern array are formed in an intaglio form or an engraving form. Alternatively, the first pattern array or the second pattern array is formed on at least one surface of the first pattern layer or the second pattern layer. More preferably, the patterns included in the first pattern array or the second pattern array have a cutting surface of any one shape of a polygonal shape, a circular shape, and an oval shape.

Preferably, the optical sheet includes a sheet layer having at least one of a reflective sheet, a diffusion sheet, a brightness enhancement film (BEF), a dual brightness enhancement film (DBEF), a composite sheet including a lens pattern sheet, and a micro lens array (MLA) sheet. More preferably, the sheet layer is formed beneath the first pattern layer or the second pattern layer.

Preferably, the patterns included in the first pattern array are different from the patterns included in the second pattern array.

Preferably, the optical sheet further includes a third pattern layer formed with a third pattern array that overlaps with the first pattern array or the second pattern array.

Preferably, when the first pattern array and the second pattern array include patterns in an intaglio form, an air layer having a previously defined thickness is formed between the first pattern layer and the second pattern layer.

Preferably, the optical sheet includes transparent resin and further includes a transparent base layer that is formed beneath the first pattern layer. More preferably, the transparent base layer includes at least one of poly-ethylene terephthalate (PET) resin, polycarbonate (PC) resin, poly-methyl methacrylate (PMMA) resin, and polystyrene (PS) resin or the first pattern layer or the second pattern layer includes at least one of at least one thermosetting resin component selected from epoxy, urea, melamine, phenol, unsaturated polyester, and resorcinol, at least one thermoplastic resin component selected from acryl, urethane, vinyl acetate, polyvinylalcohol, polyvinyl chloride, polyvinyl acetal, saturated polyester, polyamide, and polyethylene, and UV curable adhesive component including epoxy resin or urethane resin.

Preferably, the second pattern layer is stacked beneath the transparent base layer or is stacked between the first pattern layer and the transparent base layer, when the second pattern layer is stacked beneath the transparent base layer, the first pattern array and the second pattern array includes the same number of patterns, and when the second pattern layer is stacked between the first pattern layer and the transparent base layer, the first pattern array includes a larger number of patterns than that of the second pattern array. More preferably, when the first pattern array includes the same number of patterns as the second pattern array, the first pattern array includes patterns in an intaglio form and the second pattern array includes patterns in an engraving form or when the first pattern array includes a larger number of patterns than that of the second pattern array, the first pattern array includes patterns in an intaglio form and the second pattern array includes patterns in an engraving form, and when the first pattern array includes patterns in an engraving form, the second pattern array includes patterns in an intaglio form. Alternatively, when the first pattern array and the second pattern array have the same number of patterns, the first pattern array is formed on the top surface of the first pattern layer and the second pattern array is formed beneath the second pattern layer and when the first pattern array includes a larger number of patterns than that of the second pattern array, the first pattern array is formed on the top surface of the first pattern layer and the second pattern array is formed on the top surface of the second pattern layer.

Preferably, the patterns included in the first pattern array has the same size as the patterns included in the second pattern array or is larger in size than the patterns included in the second pattern array.

Preferably, when the second pattern layer is stacked between the first pattern layer and the transparent base layer or is stacked beneath the transparent base layer and the second pattern layer is stacked between the first pattern layer and the transparent base layer, the third pattern layer is stacked between the first pattern layer and the second pattern layer or is stacked between the second pattern layer and the transparent base layer or is stacked beneath the transparent base layer and when the second pattern layer is stacked beneath the transparent base layer, the third pattern layer is stacked between the first pattern layer and the transparent base layer, stacked between the transparent base layer and the second pattern layer, or stacked beneath the second pattern layer.

Preferably, the patterns included in the first pattern array or the second pattern array are patterns in an intaglio form or patterns in an engraving form and have any one of a semi-spherical shape, a cone shape, and a circular truncated cone shape and when the patterns are a semi-spherical shape or a cone shape, the size of the patterns has 5 μm to 20 μm on radius on a base side and 5 μm to 20 μm in height and when the patterns are a truncated cone shape, the size of the patterns has 20 μm to 50 μm radius on the base side, 5 μm to 15 μm radius on the top side, and 10 μm to 20 μm in height.

Preferably, the optical sheet with a moire fringe further includes a first substrate layer that is formed on the bottom surface of the first pattern layer, including the same component as the first pattern layer ; a second substrate layer that is formed on the bottom surface of the second pattern layer, including the same component as the second pattern layer, wherein the thickness value of the first substrate layer or the second substrate layer is 0.1% to 50% of the thickness value of the first pattern layer or the second pattern layer. More preferably, the transparent base layer is formed to have a thickness of 125 μm to 250 μm, the first pattern layer or the second pattern layer is formed to have a thickness of 20 μm to 60 μm, and the first substrate layer or the second substrate layer is formed to have a thickness of 2 μm to 10 μm.

In addition, the present invention provides an optical sheet that includes a pattern layer having the first pattern array formed on one surface thereof and the second pattern array, which generates the moire fringe by overlapping with the first pattern array, formed on the other surface thereof.

Preferably, a first direction angle, which one-dimensionally or two-dimensionally expresses a direction in which the patterns forming the first pattern layer are aligned and a second direction angle, which one-dimensionally or two-dimensionally expresses a direction in which the patterns forming the second pattern layer are aligned, are different from each other.

Preferably, the first pattern array or the second pattern array is a set of patterns regularly each aligned at predetermined intervals and the second pattern array includes at least one pattern that completely overlaps with one pattern of the first pattern array and at least one pattern that partly overlaps with one pattern of the first pattern array.

Preferably, the optical sheet further includes a sheet layer including at least one of a reflective sheet, a diffusion sheet, a brightness enhancement film (BEF), a dual brightness enhancement film (DBEF), a composite sheet including a lens pattern sheet, and a micro lens array (MLA) sheet. More preferably, the sheet layer is stacked beneath the pattern layer.

Preferably, when the first pattern array and the second pattern array includes patterns in an intaglio form, an air layer having a predetermined thickness is formed between the first pattern layer and the second pattern layer.

Further, there is provided a composite sheet including: a first optical sheet on which a first pattern array is formed and a second optical sheet on which a second pattern array generating a moire fringe by overlapping with the first pattern array is formed.

Preferably, a first direction angle, which one-dimensionally or two-dimensionally expresses a direction in which the patterns forming the first pattern layer are aligned and a second direction angle, which one-dimensionally or two-dimensionally expresses a direction in which the patterns forming the second pattern layer are aligned, are different from each other.

Preferably, the first pattern array or the second pattern array is a set of patterns regularly aligned at each predetermined interval and the second pattern array includes at least one pattern that completely overlaps with one pattern of the first pattern array and at least one pattern that partly overlaps with one pattern of the first pattern array.

Preferably, the first optical sheet has the first pattern array formed on one surface thereof and a third pattern array, which overlaps with the first pattern array, formed on the other surface thereof.

In addition, the present invention provides a method for producing an optical sheet with a moire fringe including: (a) forming a first pattern array including specified patterns on one surface to produce a first pattern layer; (b) forming a second pattern array, at least a part of which overlaps with the first pattern array, on one surface to produce a second pattern layer; (c) producing an optical sheet with a moire sheet by stacking a transparent base layer including a transparent material and the second pattern layer beneath the first pattern layer.

Preferably, the step (c) stacks the second pattern layer beneath the first pattern layer by a first direction angle, which one-dimensionally or two-dimensionally expresses a direction in which the patterns forming the first pattern layer are aligned and a second direction angle, which one-dimensionally or two-dimensionally expresses a direction in which the patterns forming the second pattern layer are aligned, are different from each other.

More preferably, step (a) or step (b) regularly aligns patterns at a predetermined interval to form the first pattern array or the second pattern array and step (c) stacks the second pattern layer beneath the first pattern layer so that the second pattern array includes at least one pattern that completely overlaps with one pattern of the first pattern array and at least one pattern that partly overlaps with one pattern of the first pattern array. More preferably, the step (c) tiltly stacks the second pattern layer clockwise or counterclockwise with respect to the first pattern layer so that a difference between the first direction angle and the second direction angle exceeds 0° and is less than 90°.

Preferably, the step (c) stacks the second pattern layer beneath the transparent base layer when the first pattern array and the second pattern array includes the same number of patterns and stacks the second pattern layer between the first pattern layer and the transparent base layer when the first pattern array include a larger number of pattern than that of the second pattern array.

More preferably, when the first pattern array includes the same number of patterns as second pattern array, the step (a) forms the first pattern array including patterns in an intaglio form and the step (b) forms the second pattern array including patterns in an engraving form, when the first pattern array includes a larger number of patterns than that of the second pattern array, the step (b) forms the second pattern array including patterns in an engraving form when the first pattern array includes patterns in an engraving form and forms the second pattern array including patterns in an engraving form when the first pattern array includes patterns in an intaglio form. Alternatively, when the first pattern array and the second pattern array have the same number of patterns, the step (a) forms the first pattern array on the top surface of the first pattern layer and the step (b) forms the second pattern array beneath the second pattern layer and when the first pattern array includes a larger number of patterns than that of the second pattern array, the step (a) forms the first pattern array on the top surface of the first pattern layer and the step (b) forms the second pattern array on the top surface of the second pattern layer.

Preferably, the method for producing the optical sheet with a moire fringe further includes (d) stacking a sheet layer including at least one of a reflective sheet, a diffusion sheet, a brightness enhancement film (BEF), a dual brightness enhancement film (DBEF), a composite sheet including a lens pattern sheet, a micro lens array (MLA) sheet on the transparent base layer or the bottom surface of the second pattern layer.

Preferably, (b′), which is an intermediate step of the step (b) and the step (c), forms a pattern array including a pattern that has a structure symmetrical to the first pattern layer or the second pattern layer and completely overlaps with one pattern of the first pattern array or the second pattern array and at least one pattern that partly overlaps with one pattern of the first pattern array or the second pattern array on one surface to produce at least one third pattern layer, the step (c) stacks the third pattern layer between the first pattern layer and the second pattern layer, stacks between the second pattern layer and the transparent base layer or beneath the transparent base layer when the second pattern layer is stacked between the first pattern layer and the transparent base layer, and stacks the third pattern layer between the first pattern layer and the transparent base layer, stacks between the transparent base layer and the second pattern layer, or stacks beneath the second pattern layer when the second pattern layer is stacked beneath the transparency base layer.

Preferably, step (b′), which is an intermediate step of the step (b) and the step (c) includes a first substrate layer that forms the bottom surface of the first pattern layer, including the same component as the first pattern layer; and forming a second substrate layer on the bottom surface of the second pattern layer, including the same component as the second pattern layer and the step (b′) forms the first substrate layer or the second substrate layer so that the thickness value of the first substrate layer or the second substrate layer is 0.1% to 50% of the thickness value of the first pattern layer or the second pattern layer More preferably, the step (c) uses the transparent base layer formed to have a thickness of 125 μm to 250 μm, the first pattern layer or the second pattern layer formed to have a thickness of 20 μm to 60 μm, and the first substrate layer or the second substrate layer formed to have a thickness of 2 μm to 10 μm when producing the moire sheet.

In addition, the present invention provides a backlight assembly including: any one sheet of an optical sheet that includes a first pattern layer on which a first pattern array is formed and a second pattern layer on which a second pattern array generating a moire fringe by overlapping with the first pattern array is formed, an optical sheet that includes a pattern layer having the first pattern array formed on one surface thereof and the second pattern array, which generates the moire fringe by overlapping with the first pattern array, formed on the other surface thereof, and a composite sheet that includes a first optical sheet on which the first pattern array is formed and a second optical sheet on which the second pattern array generating the moire fringe by overlapping with the first pattern array is formed; and a light source unit that generates light and irradiates the generated light as incident light to the optical sheet.

Preferably, the light source unit includes at least two light emitting diodes (LEDs) and when the density of the patterns per unit area of the optical sheet is a reference value or more, reduces the number of light emitting diodes that irradiate light to the unit area to control the number of light emitting diodes mounted on the light source unit.

Preferably, the backlight assembly is mounted on the display device that displays images using a back light source.

Preferably, the optical sheet includes a sheet layer having at least one of a reflective sheet, a diffusion sheet, a brightness enhancement film (BEF), a dual brightness enhancement film (DBEF), a composite sheet including a lens pattern sheet, and a micro lens array (MLA) sheet and further includes a sheet layer that is stacked beneath the second pattern layer.

### Mode for the Invention

Hereinafter, preferred embodiments of the present invention will be described in detail with reference to the accompanying drawings. First of all, we should note that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the preferred embodiment of the present invention will be described, but it will be understood to those skilled in the art that the spirit and scope of the present invention are not limited thereto and various modifications and changes can be made.

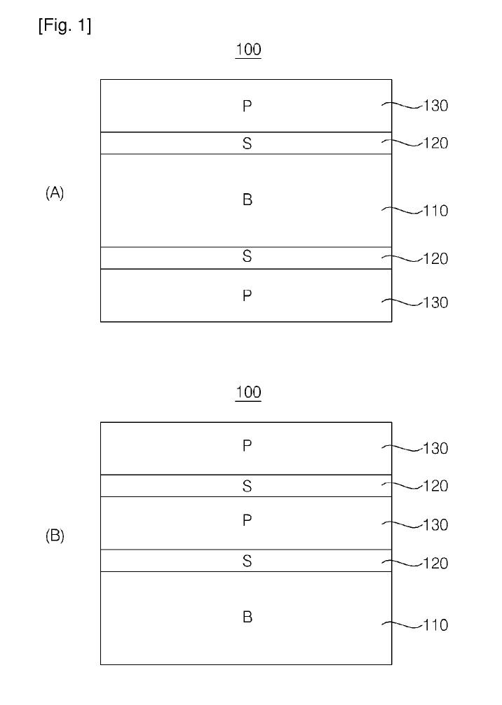

FIG. 1 is a cross-sectional view of an optical sheet with a moire fringe according to a preferred embodiment of the present invention. Referring to FIG. 1, an optical sheet 100 with a moire fringe includes a transparent base layer 110, a substrate layer 120, and a pattern layer 130. The detailed description will be described with reference to FIG. 1. Meanwhile, ‘the optical sheet 100 with a moire fringe’ is referred to as a ‘moire sheet 100’ for convenience.

The moire sheet 100, which is an optical sheet included in the backlight assembly, includes one transparency base layer 110, at least two substrate layers 120, and at least two pattern layers 130. However, in the embodiment, the configuration of the moire sheet 100 is not necessarily limited thereto. For example, the moire sheet 100 can be configured of only at least two pattern layers 130 or can be configured of only a single pattern layer 130 on which different patterns are formed in order to express the moire fringe on both sides.

The transparent base layer 110 is a base film layer including a base that transmit back light to a display panel. In the embodiment, the transparent base layer 110 is formed in the moire sheet 100 as a single layer and is formed at the following position in detail. First, where there are no pattern layers 130 between two substrates 120, the transparent base layer 110 is positioned between two substrate layers 120. In FIG. 1A, the position of the transparent base layer 110 can be confirmed. Second, when there are pattern layers 130 between two substrate layers 120, the transparent base layer 110 is positioned to be stacked on an outer exposure surface of the substrate layer 120 that is not surrounded by the pattern layers 130. In FIG. 1B, a position of the transparent base layer 110 can be confirmed. Meanwhile, the back light unit, which performs a display function of a display, includes a backlight source and a display panel includes an LCD panel.

FIGS. 1A and 1B show a position of the transparent base layer 110 when there are two substrate layers 120 and two pattern layers 130, respectively. However, in the embodiment, three or more substrate layers 120 and three or more pattern layers 130 can be included in the moire sheet 100. In this case, the transparent base layer 110 may be positioned according to the above description, but is not necessarily limited thereto.

The transparent base layer 110 includes at least one of resins having excellent transmittance, such as poly-ethylene terephthalate (PET) resin, poly-carbonate (PC) resin, poly-methyl methacrylate (PMMA) resin, poly-styrene (PS) resin, and the like. Preferably, the transparent base layer 110 includes the PET resin. The reason is that the PET resin has excellent heat resistance and electrical property but is little affected by temperature and humidity. Therefore, the PET resin is very suitable as an optical sheet attached to a backlight assembly.

The transparent base layer 110 is formed to have a thickness of 10 μm to 2000 μm so that an interference fringe is expressed by the harmony of the pattern layers 130. Preferably, the transparent base layer 110 is formed to have a thickness of 125 μm to 250 μm so that a moire fringe is clearly expressed on a front surface of a moire sheet 100.

The transparent base layer 110 can be produced in an ITO film form by performing indium tin oxide (ITO) processing, which is a thin film deposition process, on a PET fabric so that it is formed to have a thickness of 10 μm to 2000 μm. For example, the transparent base layer 110 can be produced in the ITO film form by depositing the ITO on the PET fabric in a film type by a sputtering method. In this case, it is preferable that the transparent base layer 110 is produced considering under coating processing, index matching, etc., so that ray transmittance is 90% or more and haze is 0.9 to 1.2. In addition, the transparent base layer 110 reduces the thickness of a PET fabric layer and an ITO layer and makes a resistance value of the ITO layer large, making it possible to increase the ray transmittance.

The pattern layer 130 is a pattern array layer that forms a pattern array on one surface thereof. In the above description, the pattern array means a set of regularly (or irregularly) formed specific patterns. Further, regularly forming the patterns means that the patterns having the same shape are formed at a predetermined interval. When the pattern is regularly formed, the excellent optical sheet that does not have sheet deformation can be mass-produced by uniformly responding to deformations due to external forces such as heat, humidity, etc.

At least two pattern layers 130 are provided on the moire sheet 100. The pattern layers 130 on the moire sheet 100 forms a tilt therebetween. When among the pattern layers 130 provided on the moire sheet 100, any one pattern layer 130 is referred to as a first pattern layer and the other pattern layer 130 is referred to as a second pattern layer, the tilt means an angle that the second pattern layer is tilted with respect to the first pattern layer. The tilt may be defined by an angle that is formed by one side of patterns of the first pattern layer and one side of patterns of the second pattern layer. In the above description, one side means a straight line that connects at least two patterns provided on the first pattern layer (or second pattern layer). The tilt can be defined by an angle that is formed by one surface by at least two sides of the first pattern layer and one surface by at least two sides of the second pattern layer. According to the former, the tilt means that a first direction angle, which one-dimensionally expresses a direction in which the patterns provided on the first pattern layer are aligned and a second direction angle, which one-dimensionally expresses a direction in which the patterns provided on the second pattern layer are aligned, are different from each other. According to the latter, the tilt means that a first direction angle, which two-dimensionally expresses a direction in which the patterns provided on the first pattern layer are aligned and a second direction angle, which two-dimensionally expresses a direction in which the patterns provided on the second pattern layer are aligned, are different from each other. The moire fringe can be observed in the moire sheet 100 according to the structure of the pattern layers 130.

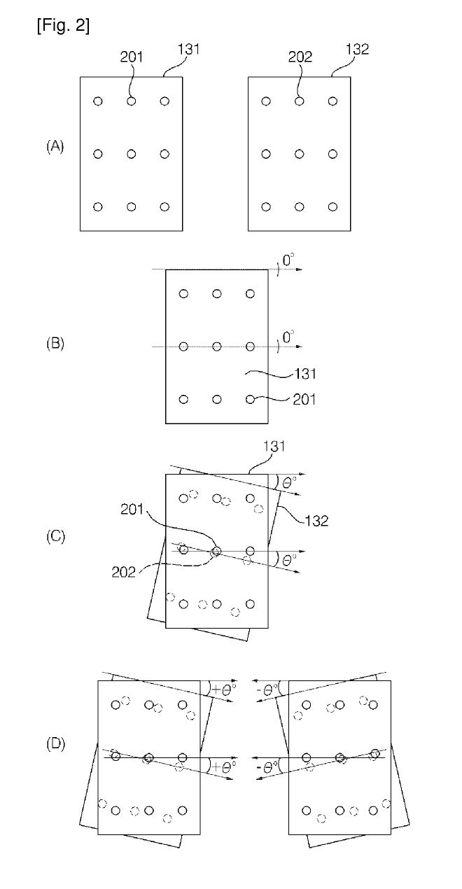

Hereinafter, a process that the moire sheet 100 has the moire fringe will be described in detail. FIG. 2 is a reference diagram for explaining a process of forming the moire fringe of the moire sheet. The following description will be described with reference to FIG. 2.

First, assume that a first pattern layer 131 and a second pattern layer 132 are provided on the moire sheet 100 and the first pattern layer 131 is positioned at a surface higher than the second pattern layer 132. The first pattern layer 131 and the second pattern layer 132 have the same pattern array as shown in FIG. 2A. In addition, one pattern provided on the first pattern layer 131 is referred to as a first pattern 201 and one pattern provided on the second pattern layer 132 is referred to as a second pattern 202.

When the first pattern layer 131 is stacked on the second pattern layer 123 without the first pattern layer 131 being tilted, only the first pattern 201 is observed since the first pattern 201 completely overlaps with the second pattern 202 when viewed from the top side as shown in FIG. 2B. In this case, the moire sheet 100 does not form the moire fringe or expresses a very blur moire fringe, which can be disregarded. At this time, the tilt between the first pattern layer 131 and the second pattern layer 132 is 0°.

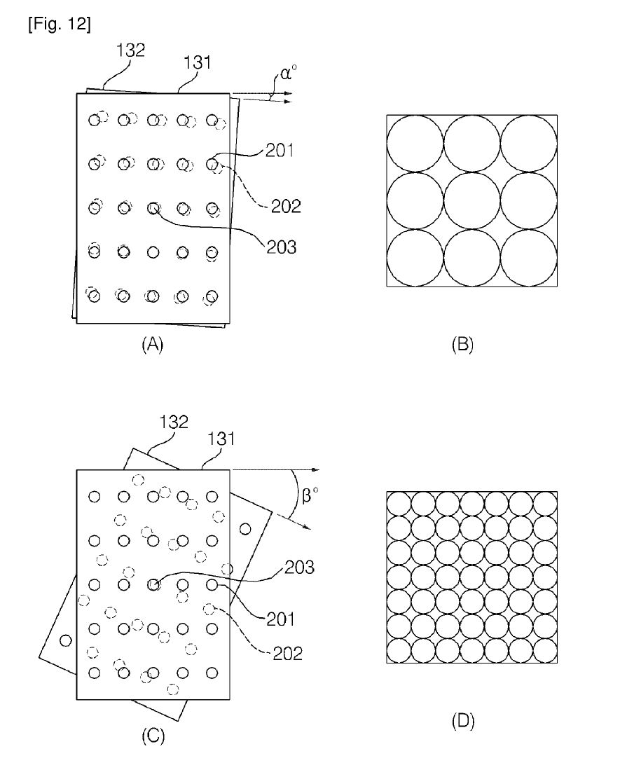

On the other hand, as shown in FIG. 2C, when the first pattern layer 131 is stacked to be tilted while being formed on the second pattern layer 132 at a predetermined angle (ex, tilt value of 0°), the moire sheet 100 clearly expresses the moire fringe while the first pattern 201 and the second pattern 202 are partly overlapped with each other when viewed from the top side. The more detailed description will be described below with reference to FIG. 12.

When the moire sheet 100 expresses the moire fringe, the tilt formed by the first pattern layer 131 and the second pattern layer 132 is −90° to +90°. Referring to FIG. 2D, when the second pattern layer 132 is rotated clockwise with respect to the first pattern layer 131 so that they are deviated from each other, the tilt between the first pattern layer 131 and the second pattern layer 132 has a plus (+) value. On the other hand, when the second pattern layer 132 is rotated counterclockwise with respect to the first pattern layer 131 so that they are deviated from each other, the tilt between the first pattern layer 131 and the second pattern layer 132 has a minus (+) value.

The following description will be described with reference to FIG. 12.

Generally, the moire fringe may be defined by an interference fringe made when two or more periodic patterns overlaps with each other. In the embodiment, the moire fringe is generated as a new pattern similar to the patterns of both layers 131 and 132 combined each time the patterns formed on the first pattern layer 131 overlaps with the patterns formed on the second pattern layer 132 based on a so-called beating phenomenon. Hereinafter, a newly generated pattern is referred to as a moire pattern.

However, the moire fringe is expressed like the patterns formed on the first pattern layer 131 and the second pattern layer 132 that are expanded when a large number of patterns overlap with each other on both layers 131 and 132. Referring to FIG. 12A, when the tilt value (α°) is small while a common positional pattern 203 of both layers 131 and 132 is fixed and the second pattern layer 132 is rotated clockwise with respect to the first pattern layer 131, a partial overlapping phenomenon occurs in most patterns of both layers 131 and 132. In other words, while the interference between the patterns of both layers 131 and 132 is increased, the moire patterns 204 having a larger size that that of the patterns 201 and 202 of both layers 131 and 132 are generated as shown in FIG. 12B.

On the other hand, when the tilt value (β°,β>α) is large and the second pattern layer 132 is rotated clockwise with respect to the first pattern layer 131 as shown in FIG. 12C, the partial overlapping phenomenon occurs only in some patterns of both layers 131 and 132. In this case, the interference between the patterns of both layers 131 and 132 is small and as shown in FIG. 12D, the moire patterns 204 having an approximately same size as the patterns 201 and 202 of both layers 131 and 132 are generated.

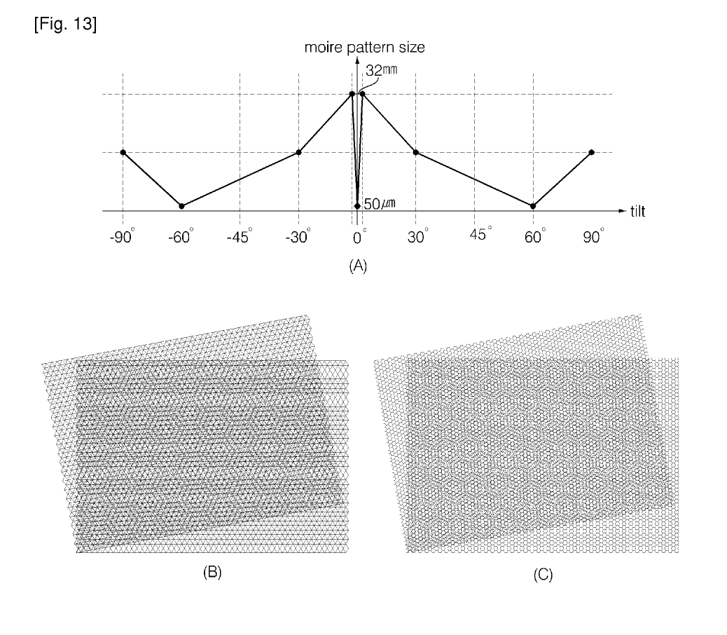

FIGS. 13 to 15 show the change in the size of the moire pattern according to the tilt value when the shape of the patterns of both layers 131 and 132 is a regular triangle, a regular hexagon, a regular square, and a regular pentagon. Hereinafter, the embodiment will be described with reference to FIGS. 13 to 15.

FIG. 13 shows a case where the shape of the patterns formed on the first pattern layer and the second pattern layer is a regular triangle or a regular hexagon. FIG. 13A is a graph showing the change in the size of the moire pattern according to the tilt value. As shown in FIG. 13A, when the tilt value is 6°, the size of the moire pattern has a maximum value and when the tilt value is 60°, the size of the moire pattern has a minimum value. The reason that when the tilt value is 60°, the size of the moire pattern has a minimum value is that the interference between the patterns of both layers 131 and 132 is removed at this angle. Meanwhile, when the tilt value is increased from 0° to 6°, the size of the moire pattern is exponentially increased since the interference between the patterns of both layers 131 and 132 is suddenly increased. In the case of performing the experiment using both layers 131 and 132 on which the patterns in a regular triangle having 10 μm in a length of each side or the patterns in a regular hexagon are formed, the size of the moire pattern is about 4 mm when the tilt value is 2° and the size of the moire pattern is about 12 mm when the tilt value is 4°. In addition, when the tilt value is 6°, the size of the moire pattern has a maximum value of about 32 mm and when the tilt value is 60°, the size of the moire pattern has a minimum value of about 50 μm.

Meanwhile, FIG. 13B shows the moire pattern when the shape of the pattern is a regular triangle and the tilt value is 10° and FIG. 13C shows the moire pattern when the shape of the pattern is a regular hexagon and the tilt value is 10°.

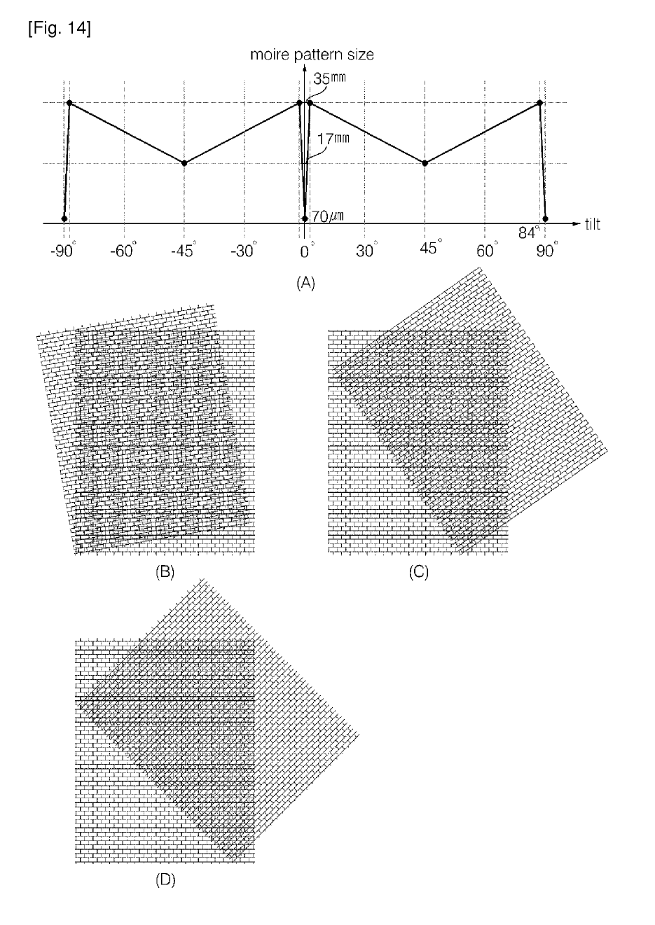

FIG. 14 shows a case where the shape of the patterns formed on the first pattern layer and the second pattern layer is a regular square. FIG. 14A is a graph showing the change in the size of the moire pattern according to the tilt value. As shown in FIG. 14A, when the tilt value is 6° and 84°, the size of the moire pattern has a maximum value and when the tilt value is 90°, the size of the moire pattern has a minimum value. In the case of performing the experiment using both layers 131 and 132 on which the patterns in a regular square having 10 μm in a length of each side are formed, the size of the moire pattern has a maximum value that is about 35 mm when the tilt value is 6° and 84° and the size of the moire pattern has a minimum value that is about 70 mm when the tilt value is 90°. When the tilt value is 45°, the size of the moire pattern is about 17 mm.

Meanwhile, FIG. 14B shows the moire pattern when the shape of the pattern is a regular triangle and the tilt value is 10°, FIG. 14C shows the moire pattern when the pattern shape is a regular square and the tilt value is 35°, and FIG. 14D shows the moire pattern when the shape of the pattern is a regular square and the tilt value is 45°.

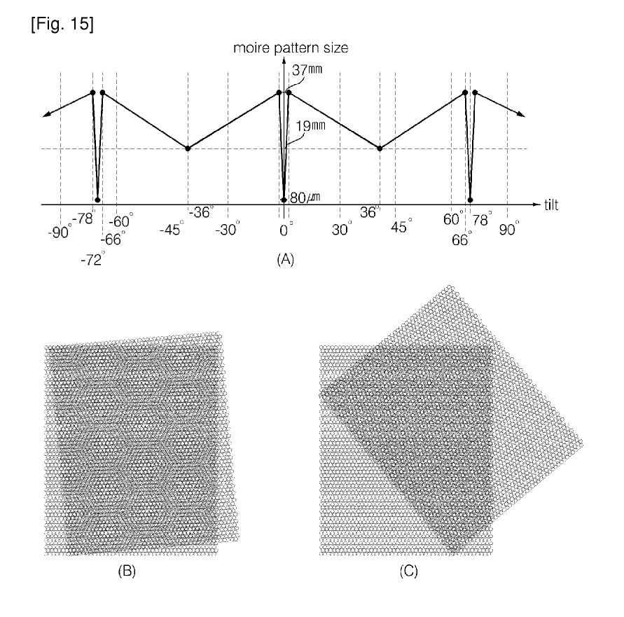

FIG. 15 shows a case where the shape of the patterns formed on the first pattern layer and the second pattern layer is a regular pentagon. As shown in FIG. 15A, when the tilt value is 6°, 66°, and 78°, the size of the moire pattern has a maximum value and when the tilt value is 72°, the size of the moire pattern has a minimum value. In the case of performing the experiment using both layers 131 and 132 on which the patterns in a regular pentagon having 10 μm in a length of each side are formed, the size of the moire pattern has a maximum value that is about 37 mm when the tilt value is 6°, 66°, and 78° and the size of the moire pattern has a minimum value that is about 80 mm when the tilt value is 72°.

Meanwhile, FIG. 15B shows the moire pattern when the pattern shape is a regular pentagon and the tilt value is 5° and FIG. 15C shows the moire pattern when the pattern shape is a regular pentagon and the tilt value is 40°.

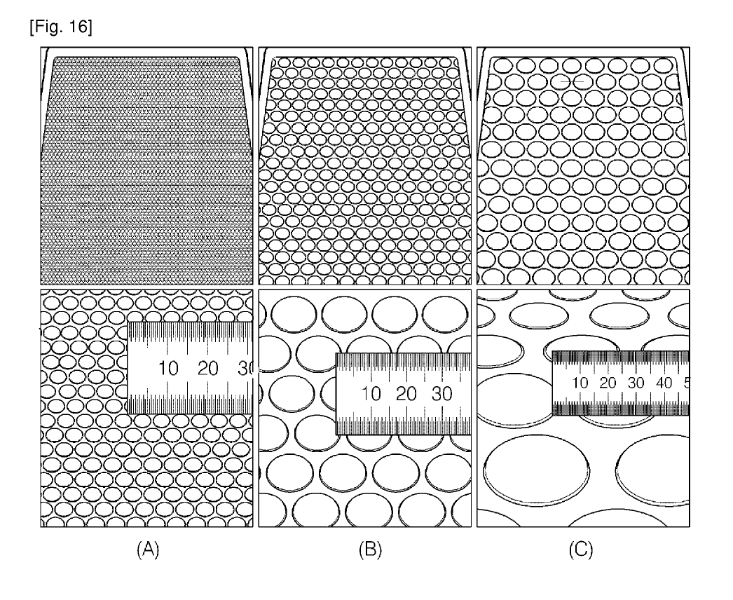

FIG. 16 shows a diagram showing the change in the size of the moire pattern according to the tilt value when the pattern shape is a circle. In FIG. 16A, the size of the moire pattern is about 4 mm when the tilt value is 2°. And, in FIG. 16B, the size of the moire pattern is about 12 mm when the tilt value is 4°. In addition, in FIG. 16C, when the tilt value is 6°, the size of the moire pattern has a maximum value of about 32 mm. According to FIGS. 16A to 16C, the size of the moire pattern changes by the tilt value.

The description will be made by referring again to FIG. 1.

The pattern layer 130 is bonded to the substrate layer 120 through one surface. All the pattern layers 130 are not necessarily bonded to the substrate layer 120. In the embodiment, at least two pattern layers 130 are provided on the moire sheet 100 while being bonded to the substrate layer 120, making it possible to clearly express the moire fringe.

The pattern layer 130 includes adhesive component having excellent adhesive strength so that it can be easily bonded to the substrate layer 120. In the embodiment, the pattern layer 130 includes thermosetting rein component such as epoxy, urea, melamine, phenol, unsaturated polyester, resorcinol, etc., or thermoplastic resin component such as acryl, urethane, vinyl acetate, polyvinylalcohol, polyvinyl chloride, polyvinyl acetal, saturated polyester, polyamide, polyethylene, etc., as adhesive component. Preferably, the pattern layer 130 includes epoxy resin, urethane resin, acrylic resin, etc., as adhesive components. The reason is that the epoxy resin, urethane resin, acrylic resin, etc., have excellent adhesive strength and does not generate byproducts at the time of reaction as compared to other resins. In addition, the processing thereof can be easily performed and they can be easily obtained and are inexpensive.

When the pattern layer 130 includes the epoxy resin or the urethane resin as the adhesive components, it is preferable that the pattern layer 130 includes the epoxy adhesive, the urethane adhesive, etc. The epoxy adhesive further includes hardener, filler, diluent, and other additives, etc., in addition to the epoxy resin, making it possible to control curing time, viscosity, etc., and further reduce costs and improve functionality. The urethane adhesives further include diisocyanate, chain extender, solvent, and other additives, etc., in addition to the urethane resin, making it possible to reinforce impact resistance and flexibility.

The pattern layer 130 can include ultra-violet (UV) curable adhesives as adhesive components. The UV curable adhesive, which includes the epoxy resin, the urethane resin, etc., as oligomer, is pollution-free since it does not use an organic solvent and can perform adhesion at a short time. In addition, it is cured even at low temperature to obtain very excellent adhesive strength and a coating effect.

Further, the pattern layer 130 can include mixed resin components of vinyl, phenol-chloroprene rubber, polyamide, natrile rubber-epoxy, etc., or natural resin component of starch, dextrin, glue, casein, latex, gum, pine resin, shellac, etc., as adhesive components.

The pattern layer 130 is formed to have a thickness of 500 μm or less considering a width and a depth of the united pattern. Preferably, the pattern layer 130 is formed to have a thickness of 0.5 μm to 100 μm to clearly express the moire fringe.

Described above is the case where at least two pattern layers 130 are provided on the moire sheet 100.

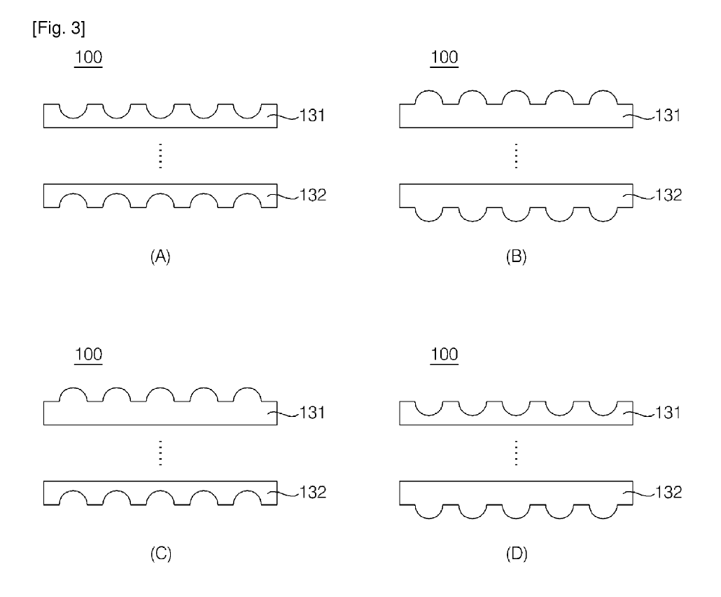

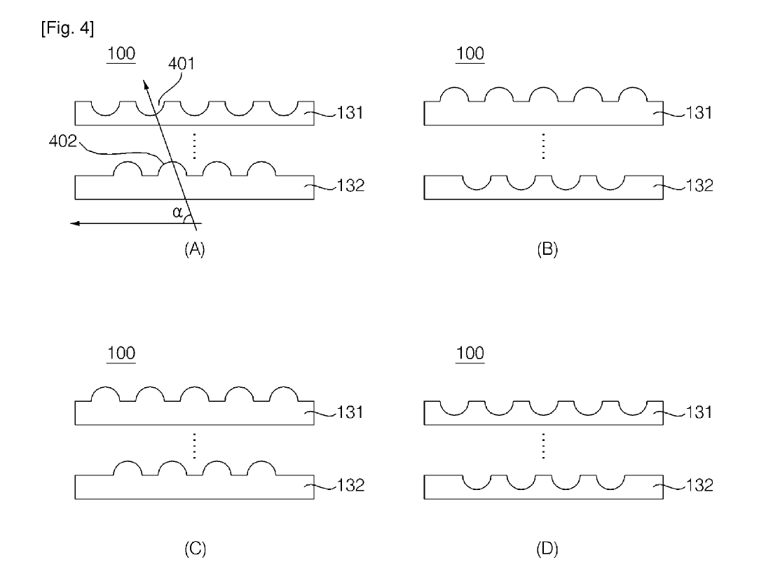

Hereinafter, a pattern included in each pattern layer will be described considering that two pattern layers 130 are provided on the moire sheet 100. FIGS. 3 and 4 are reference diagrams for explaining the pattern forms of each pattern layer that is provided on the moire sheet. In detail, FIG. 3 shows a pattern form of the first pattern layer 131 and the second pattern layer 132 in the case where the moire sheet 100 has a structure like FIG. 1A and FIG. 4 shows a pattern form of the first pattern layer 131 and the second pattern layer 132 in the case where the moire sheet 100 has a structure like FIG. 1B. The following description will be described with reference to FIGS. 3 and 4.

Referring first to FIG. 3, when there is the transparent base layer 110 between two pattern layers 130, there are four types according to whether each of the first pattern layer 131 and the second pattern layer 132 has any pattern array of the intaglio pattern array and the engraving pattern array. Describing in detail, the first type shown in FIG. 3A corresponds to the case where both the first pattern layer 131 and the second pattern layer 132 have the engraving pattern array and the second type shown in FIG. 3B corresponds to the case where both the first pattern layer 131 and the second pattern layer 132 have the intaglio pattern array. The third type shown in FIG. 3C corresponds to the case where the first pattern layer 131 has the intaglio pattern array and the second pattern layer 132 has the engraving pattern array and the fourth type shown in FIG. 3D corresponds to the case where the first pattern layer 131 has the engraving pattern array and the second pattern layer 132 has the intaglio pattern array. In the first type to the fourth type, the first pattern layer 131 is formed considering a visual point positioned on the top side of the moire sheet 100 and the form of the second pattern layer 131 is formed considering a visual point positioned at the bottom side of the moire sheet 100.

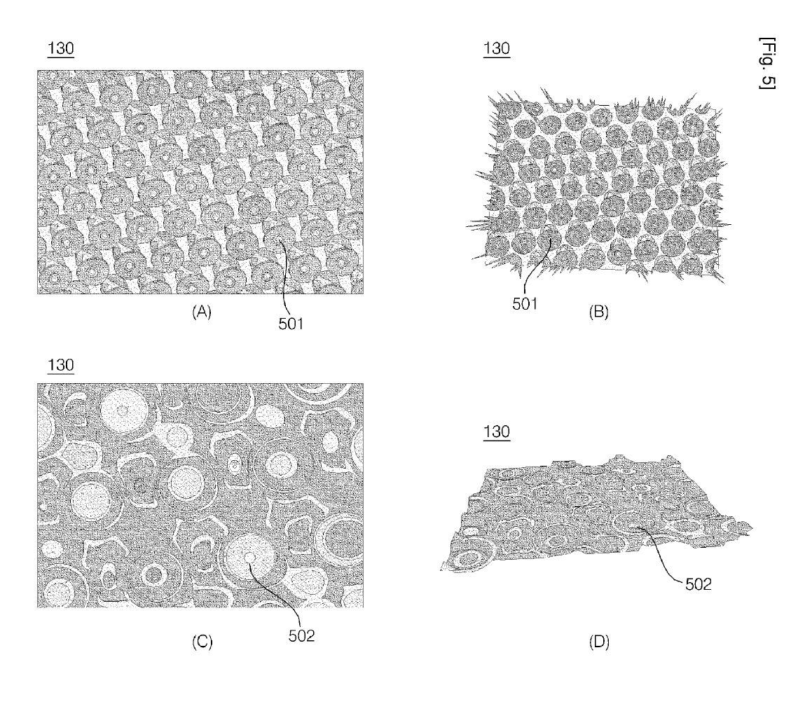

FIGS. 5A and 5B show a substantial implementation example of the pattern layer 130 including the intaglio pattern array and FIGS. 5C and 5D show a substantial implementation example of the pattern layer 130 including the engraving pattern array. In FIGS. 5A and 5B, reference numeral 501 is the intaglio pattern and in FIGS. 5C and 5D, reference numeral 502 is the engraving pattern.

Although this is described below with reference to the experimental example, the first type to the fourth type are excellent in view of all the specifications as compared to the existing optical sheet when considering specifications in respect to a haze numerical value, transmittance of diffusion of transmitted light (D) (or transmittance of scattered light), transmittance of total transmitted light (T), transmittance of parallel of transmitted light (P) (or transmittance of transmitted light), etc. The reason is that the pattern array of at least one pattern layer of the first pattern layer 131 and the second pattern layer 132 uniformly scatters light in all directions when considering the progress direction of light. Since each type has a minute difference in view of their characteristics, they are variously selected and used by the user, making it possible to change the characteristics of the display module.

Referring next to FIG. 4, when there is no transparent base layer 110 between two pattern layers 130, there may be four types according to whether each of the first pattern layer 131 and the second pattern layer 132 has any pattern array of the intaglio pattern array and the engraving pattern array. Describing in detail, the fifth type shown in FIG. 4A corresponds to the case where the first pattern layer 131 has the engraving pattern array and the second pattern layer 132 has the intaglio pattern array and the sixth type shown in FIG. 4B corresponds to the case where the first pattern layer 131 has the intaglio pattern array and the second pattern layer 132 has the engraving pattern array. The seventh type shown in FIG. 4C corresponds to the case where both the first pattern layer 131 and the second pattern layer 132 have the intaglio pattern array and the eighth type shown in FIG. 4D corresponds to the case where both the first pattern layer 131 and the second pattern layer 132 have the engraving pattern array. In the fifth type to the eight type, the first pattern layer 131 and the second pattern layer 132 are formed considering the visual point positioned at the top side of the moire sheet 100.

Although this is described below with reference to the experimental example, the fifth type to the eighth type are excellent in view of all the specifications as compared to the existing optical sheet when considering specifications in respect to a haze numerical value, transmittance of diffusion of transmitted light, transmittance of total transmitted light, transmittance of parallel of transmitted light, etc. When the two pattern layers 131 and 132 approach each other like the fifth type to the eighth type, light can be uniformly scattered most effectively in all directions by the harmony of the intaglio pattern array and the engraving pattern array. Therefore, the fifth type and the sixth type are more excellent in view of all the specifications as compared to other types. More preferably, as shown in FIG. 4A, a straight line connecting one pattern 401 of the first pattern layer 131 and one pattern 402 of the second pattern layer 132 can uniformly scatter more effectively in all directions when a tilt angle (a) with respect to the moire sheet 100 is 1° to 89°. Light is optimally scattered when the tilt angle is 30° to 60°.

Referring to FIGS. 3 and 4, the foregoing describes the case where one pattern of the first pattern layer 131 and one pattern of the second pattern layer 132 have the same size. In the embodiment, one pattern of the first pattern layer 131 and one pattern of the second pattern layer 132 does not necessarily have the same size. In other words, one pattern of the first pattern layer 131 and one pattern of the second pattern layer 132 can have different sizes.

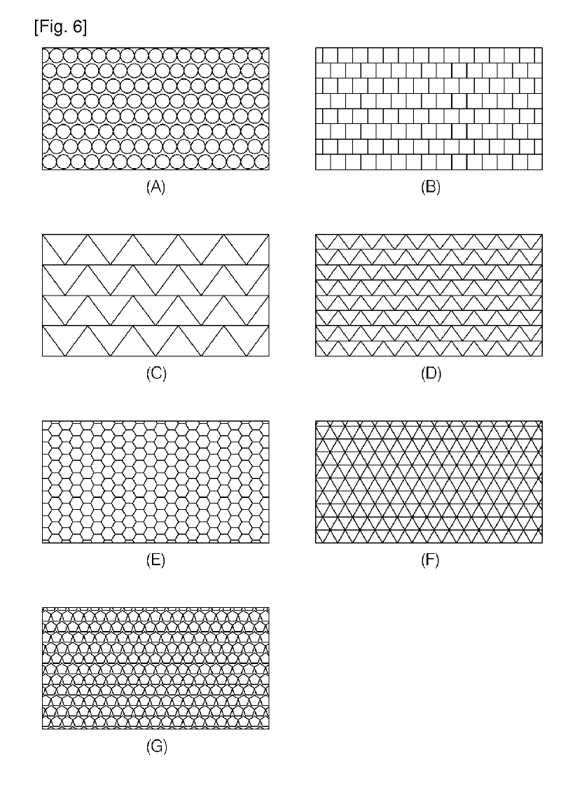

The shape of each pattern formed on the pattern layer 130 is usually a semi-spherical shape as shown in FIGS. 3 and 4. However, the embodiment is not necessarily limited thereto. As shown in FIGS. 6A to 6G, the shape of each pattern may be a polygonal shape, a circular shape, an oval shape, a diamond shape, a parallelogram shape, etc. Further, the shape of each pattern may be furrow prism. The above-mentioned shape of the pattern can be applied to an intaglio pattern and an engraving pattern.

The pattern layer 130 is repetitively formed with the same patterns. It is already described that the patterns are collectively referred to as the pattern array. However, the present embodiment is not necessarily limited thereto and therefore, each pattern layer 130 can be formed with patterns having different shapes. For example, the first pattern in a semi-spherical shape, the second pattern in a square shape, and the third pattern in a diamond shape can be formed on the pattern layer 130 as long as they are harmonized with each other.

The description will be made by referring back to FIG. 1.

The substrate layer 120 is bonded to one side of the pattern layer 130. Therefore, the substrate layers 120, which are equal to the number of the pattern layer 130, are provided on the moire sheet 100. In the embodiment, the substrate layer 120 is formed between the transparent base layer 110 and the pattern layer 130 or between two adjacent pattern layers 130.

The substrate layer 120 is formed of the same material as the pattern layer 130 considering the adhesive strength. However, the embodiment is not necessarily limited thereto. Therefore, the substrate layer 120 can be formed of materials having more excellent adhesive strength than the pattern layer 130 or can be formed including the adhesive components.

The substrate layer 120 is formed to have a thickness of 100 μm or less in order to control an interval between two adjacent pattern layers 130 or an interval between the transparent base layer 110 and the pattern layer 130. Preferably, the substrate layer 120 is formed to have a thickness of 0.1 μm to 10 μm according to the interval control to clearly express the moire fringe.

The thickness of the substrate layer 120 can be arbitrarily changed according to the thickness or number of the pattern layer 130 included on the moire sheet 100. In the embodiment, it is preferable that the thickness value of the substrate layer 120 is 0.1% to 50% of the thickness value of the pattern layer 130. The reason is that the moire sheet 100 having the substrate layer 120 clearly expresses the moire fringe at the front surface thereof.

Meanwhile, as described above, the pattern layer 130 may include the intaglio pattern array or the engraving pattern array. In addition, the moire sheet 100 may be configured of only at least one pattern layer 130. Therefore, when the moire sheet is configured of two pattern layers on which the engraving pattern arrays are formed, an air layer having a predetermined thickness may be further added between two pattern layers.

Hereinafter, advantages obtained by forming the moire fringe on the moire sheet 100 will be described below.

The LCD is driven as a principle that displays colors when light from a back-light unit (BLU) on a rear surface of a panel passes therethrough. Since the larger the amount of light capable of being emitted by the BLU, the brighter the LCD screen becomes, the LCD industries are improving the amount of light of the BLU using two methods. The first method is a method that improves the performance of the light source that emits light or increases the number of light sources to increase the amount of light. Further, the second method is a method that minimizes wasted light by using an optical film such as a diffusion sheet, a brightness enhancement film, etc.

The most important factor, which determines the amount of light of the BLU, is a light source. Up to now, most BLUs use a cold cathode fluorescent lamp (CCFL), which is a kind of a fluorescent lamp, as a light source, but the use of an external electrode fluorescent lamp (EEFL), an LED, etc., has gradually become more popular in recent years. However, as the number of these light sources, which is mounted on the BLU, is increased, the amount of light can be increased. However, as the number of light sources is increased, production costs are increased and power consumption is increased in proportion to the number of light sources. Currently, increasing the amount of light of the BLU is generally performed using the second method.

The second method uses a method of using the optical film. Since light emitted from the light source is diffused in all directions, only some light is used to implement a screen when only the light source drives the LCD panel. The optical film plays a role of minimizing wasted light by directing the direction of light to the front surface through refraction/reflection and making the screen bright. The LCD BLU uses various optical films such as a reflective sheet, a diffusion sheet, a brightness enhancement film (BEF), a lens pattern composite sheet, a dual brightness enhancement film (DBEF), etc., to perform the function of increasing the luminance of light.

The moire sheet according to the embodiment regularly aligns patterns whose size or shape are considered for every pattern layer and patterns the interference fringe using the moire phenomenon by controlling the tilt between the pattern layers. The moire sheet further improves various optical performance such as luminance, viewing angle, masking performance, diffusion function, etc., as compared to the existing optical films.

In detail, the moire sheet simultaneously performs a diffusion function and a light collection function when a point light source or a line light source is converted into a surface light source through a pattern layer on which the intaglio pattern array is formed and a pattern layer on which the engraving pattern array is formed, thereby further increasing the luminance of a lamp bright line and removing a masking phenomenon due to a light guide plate (or diffusion plate) pattern In addition, the moire sheet arbitrarily changes the size or shape of the pattern, the tilt value, the sheet design, etc., when designing the backlight assembly such that the light sources are effectively combined, thereby further improving the optical property of the backlight assembly such as luminous intensity, etc.

In addition, since the moire sheet is high in both the alignment and the uniformity, it shows excellent dimension safety with respect to the deformations due to external forces such as heat, humidity, etc., in a microscopic standpoint. Further, the top and bottom parts of the moire sheet are provided with the pattern layers based on the transparent base layer. Since the pattern layers of the moire sheet support the transparent base such that eccentricity is dispersed to both sides of the top and bottom parts of the moire sheet, the excellent optical sheet can be mass-produced without causing deformed sheets due to external forces in a macroscopic standpoint.

Further, the moire sheet in the backlight unit (BLU) having the LED light source properly disperses or collects light in a point form, which is a feature of the LED light source, through the pattern layer on which the intaglio pattern array is formed and the pattern layer on which the engraving pattern array is formed, thereby effectively removing a bright part (part of LED light source) and a dark part (part between the LEDs) and preventing a high heat phenomenon generated by the LED light emitting occurring according to the excess use of the LED In addition, the increase in production costs can be prevented as the number of LED light sources is increased and the weight of the display device can be reduced. If the moire unit is applied to the backlight unit on which the LED light source is mounted, the number of LED light sources can be minimized.

Meanwhile, as the pattern layers 130 having high density per unit area are increased, the moire sheet 100 expresses the moire fringe well, thereby further improving optical performance such as luminance, viewing angle, etc. In the embodiment, when considering the size of the patterns, if 10 to 6000 patterns are densely provided in a unit area of 1 cm², the moire fringe is clearly expressed on the front surface of the moire sheet 100. Preferably, when 3000 to 4000 patterns are densely provided in a unit area of 1 cm², the moire fringe is most clearly expressed on the front surface of the moire sheet 100.

Meanwhile, when intending to clearly express the moire fringe on the moire sheet 100, it is preferable that the uppermost layer is the pattern layer 130.

Next, one embodiment of the moire sheet according to each pattern form on the pattern layer will be described. The pattern form of the pattern layer has a first type to an eighth type, which is previously described with reference to FIGS. 3 and 4.

\textcircled{1} A Seventh Type of Pattern Form of a Pattern Layer of a Moire Sheet

The specification of the optical sheet for the produced backlight assembly is as follows. Two pattern arrays (micro lens array, MLA) of an UV curable acrylic material are stacked on the top part of at least one transparent base made of PET having a thickness of 125 μm. Each micro lens array is configured of a base layer of a thickness of 5±1 μm and a pattern layer of a thickness of 38±1 μm and the micro lenses in each micro lens array is aligned at a predetermined size and interval in a semi-spherical shape to form a regular pattern. The tilt between one pattern array and another pattern array forms an angle of +75° and two pattern arrays are configured of a pattern array of a bottom pattern formed of a (+) pattern and a pattern array of a top pattern formed of a (+) pattern. Herein, the (+) pattern indicates the intaglio pattern and the (−) pattern indicates the engraving pattern.

The experimental conditions for measuring the front luminance and viewing angle are as follows.

Size of backlight unit: 17″, measurement equipment: BM-7 luminance color system, input voltage: 12V, measurement range: −80° to +80°, measurement interval: 10 seconds, lamp: 2 ea.

As a result of measuring the front luminance and viewing angle under the above-mentioned conditions, the front luminance is 108.0% in the range of −44° to +43° (half power angle 87°) and the viewing angle is about 1400 to 2900 as compared to the general diffusion sheet.

In addition, the experimental conditions for measuring the haze, the diffusion of transmitted light (D), the total transmitted light (T), the parallel of transmitted light (P), etc., are as follows.

Input voltage: 12V, lamp current: 6.5 mA, temperature: 21° C., humidity: 40%.

As a result of measuring the haze, the diffusion of transmitted light, the total transmitted light, the parallel of transmitted light, etc., using the haze measuring instrument under the above-mentioned conditions, the haze is 77.41%, the wavelength of the total transmitted light is 51.95 nm, the wavelength of the diffusion of transmitted light is 40.21 nm, and the wavelength of the parallel of transmitted light is 11.74 nm.

All the embodiments, the haze measuring instrument used a turbidmeter (serial No.: COH300, NDH300A, NDH5000, etc.) that is marketed from Nippon Denshoku Kogyo. A principle of the haze measuring instrument is as follows.

Light from the lamp transmits a sample (transparency or translucency) and light passing through the sample is incident to an integrating sphere. At this time, light is separated into the diffusion of transmitted light and the parallel of transmitted light by the sample and the light is reflected in the integrating sphere and is then collected the light receiving device. The reason is that all light are reflected due to the existence of a material called barium lactate in the integrating sphere. The light collected by the light receiving device that is a device converting the amount of light into the electronic signal is transferred to the measuring unit, which outputs the desired measuring data to the display. In addition, the method for calculating the measuring light depends on a rotating motor and the rotation of the motor is always maintained at the time of measurement. One side of the rotating motor reflects light and the other thereof separates the parallel of transmitted light and the transmitted light by the passage of light. The haze (%) is obtained by an equation of ‘[wavelength (nm) of diffusion of transmitted light/wavelength of total transmitted light (nm)]′100’ and the wavelength (nm) of the parallel of transmitted light is obtained by an equation of ‘wavelength (nm) of total transmitted light−wavelength (nm) of diffusion of transmitted light (DT)’.

\textcircled{2} An Eighth Type of Pattern Form of a Pattern Layer of a Moire Sheet

The specification of the optical sheet for the produced backlight assembly is as follows. The tilt between one pattern array (micro lens array) and another pattern array (micro lens array) forms an angle of −60°. The size of the micro lens is larger than the case of the above case \textcircled{1}. Everything else is identical with the above case \textcircled{1}.

As a result of measuring the front luminance and viewing angle under the same experimental conditions as the above case \textcircled{1}, the front luminance is 108.4% in the range of −44° to +43° (half power angle 87°) and the viewing angle is about 1600 to 2600 as compared to the general diffusion sheet.

Likewise, as a result of measuring the haze, the diffusion of transmitted light, the total transmitted light, the parallel of transmitted light, etc., using the haze measuring instrument under the same experimental conditions as the above \textcircled{1}, the haze is 77.23%, the wavelength of the total transmitted light is 51.98 nm, the wavelength of the diffusion of transmitted light is 40.14 nm, and the wavelength of the parallel of transmitted light is 11.84 nm.

\textcircled{3} A Third Type of Pattern Form of a Pattern Layer of a Moire Sheet

The specification of the optical sheet for the produced backlight assembly is as follows. The pattern array (micro lens array) of the bottom pattern formed of a (−) pattern is stacked on the bottom part of at least one transparent base and the pattern array (micro lens array) of the top pattern formed of a (+) pattern is stacked on the top part of the transparent base. The tilt between one pattern array and another pattern array forms an angle of +90°. Everything else is identical with the above case \textcircled{1}.

As a result of measuring the front luminance and viewing angle under the same experimental conditions as the above case \textcircled{1}, the front luminance is 111.9% in the range of −53° to +52° (half power angle 105°) and the viewing angle is about 2000 to 3000 as compared to the general diffusion sheet.

Likewise, as a result of measuring the haze, the diffusion of transmitted light, the total transmitted light, the parallel of transmitted light, etc., using the haze measuring instrument under the same experimental conditions as the above case \textcircled{1}, the haze is 88.21%, the wavelength of the total transmitted light is 60.53 nm, the wavelength of the diffusion of transmitted light is 53.39 nm, and the wavelength of the parallel of transmitted light is 7.14 nm.

\textcircled{4} A Fourth Type of Pattern Form of a Pattern Layer of a Moire Sheet

The specification of the optical sheet for the produced backlight assembly is as follows. The pattern array (micro lens array) of the bottom pattern formed of a (−) pattern is stacked on the bottom part of at least one transparent base and the pattern array (micro lens array) of the top pattern formed of a (+) pattern is stacked on the top part of the transparent base. The tilt between one pattern array and another pattern array forms an angle of +60° and the size of the micro lens is larger than the case of the above case \textcircled{3}. Everything else is identical with the above case \textcircled{1}.

As a result of measuring the front luminance and viewing angle under the same experimental conditions as the above case \textcircled{1}, the front luminance is 103.8% in the range of −53° to +52° (half power angle 105°) and the viewing angle is about 1600 to 2820 as compared to the general diffusion sheet.

Likewise, as a result of measuring the haze, the diffusion of transmitted light, the total transmitted light, the parallel of transmitted light, etc., using the haze measuring instrument under the same experimental conditions as the above case \textcircled{1}, the haze is 88.53%, the wavelength of the total transmitted light is 76.09 nm, the wavelength of the diffusion of transmitted light is 67.36 nm, and the wavelength of the parallel of transmitted light is 8.73 nm.

\textcircled{5} A Second Type of Pattern Form of a Pattern Layer of Moire Sheet

The specification of the optical sheet for the produced backlight assembly is as follows. The pattern array (micro lens array) of the bottom pattern formed of a (+) pattern is stacked on the bottom part of at least one transparent base and the pattern array (micro lens array) of the top pattern formed of a (+) pattern is stacked on the top part of the transparent base. The tilt between one pattern array and another pattern array forms an angle of +90°. Everything else is identical with the above \textcircled{1}.

As a result of measuring the front luminance and viewing angle under the same experimental conditions as the above case \textcircled{1}, the front luminance is 107.8% in the range of −53.5° to +52° (half power angle 105.5°) and the viewing angle is about 2200 to 2970 as compared to the general diffusion sheet.

Likewise, as a result of measuring the haze, the diffusion of transmitted light, the total transmitted light, the parallel of transmitted light, etc., using the haze measuring instrument under the same experimental conditions as the above case \textcircled{1}, the haze is 88.55%, the wavelength of the total transmitted light is 63.34 nm, the wavelength of the diffusion of transmitted light is 56.09 nm, and the wavelength of the parallel of transmitted light is 7.25 nm.

\textcircled{6} A First Type of Pattern Form of a Pattern Layer of a Moire Sheet

The specification of the optical sheet for the produced backlight assembly is as follows. The pattern array (micro lens array) of the bottom pattern formed of a (+) pattern is stacked on the bottom part of at least one transparent base and the pattern array (micro lens array) of the top pattern formed of a (+) pattern is stacked on the top part of the transparent base. The tilt between one pattern array and another pattern array forms an angle of +60°. The size of the micro lens is larger than the case of the above case \textcircled{5}. Everything else is identical with the above case \textcircled{1}.

As a result of measuring the front luminance and viewing angle under the same experimental conditions as the above case \textcircled{1}, the front luminance is 107.9% in the range of −53.5° to +52.5° (half power angle 106°) and the viewing angle is about 2200 to 2970 as compared to the general diffusion sheet.

Likewise, as a result of measuring the haze, the diffusion of transmitted light, the total transmitted light, the parallel of transmitted light, etc., using the haze measuring instrument under the same experimental conditions as the above case \textcircled{1}, the haze is 88.64%, the wavelength of the total transmitted light is 63.36 nm, the wavelength of the diffusion of transmitted light is 56.06 nm, and the wavelength of the parallel of transmitted light is 7.30 nm.

\textcircled{7} A Fifth Type of Pattern Form of a Pattern Array of a Moire Sheet

The specification of the optical sheet for the produced backlight assembly is as follows. The pattern array (micro lens array) of the bottom pattern formed of a (+) pattern and the pattern array (micro lens array) of the top pattern formed of a (−) pattern are sequentially stacked on the top part of at least one transparent base. The tilt between one pattern array and another pattern array forms an angle of −60°. Everything else is identical with the above case \textcircled{1}.

As a result of measuring the front luminance and viewing angle under the same experimental conditions as the above case \textcircled{1}, the front luminance is 116.7% in the range of −53° to +52° (half power angle 105°) and the viewing angle is about 2300 to 3200 as compared to the general diffusion sheet.

Likewise, as a result of measuring the haze, the diffusion of transmitted light, the total transmitted light, the parallel of transmitted light, etc., using the haze measuring instrument under the same experimental conditions as the above case \textcircled{1}, the haze is 83.09%, the wavelength of the total transmitted light is 73.25 nm, the wavelength of the diffusion of transmitted light is 60.86 nm, and the wavelength of the parallel of transmitted light is 12.86 nm.

\textcircled{8} A Sixth Type of Pattern Form of a Pattern Layer of a Moire Sheet

The specification of the optical sheet for the produced backlight assembly is as follows. The pattern array (micro lens array) of the bottom pattern formed of a (+) pattern and the pattern array (micro lens array) of the top pattern formed of a (−) pattern are sequentially stacked on the top part of at least one transparent base. The tilt between one pattern array and another pattern array forms an angle of +70°. Everything else is identical with the above case \textcircled{1}.

As a result of measuring the front luminance and viewing angle under the same experimental conditions as the above case \textcircled{1}, the front luminance is 131.9% in the range of −53° to +52° (half power angle 105°) and the viewing angle is about 2300 to 3200 as compared to the general diffusion sheet.

Likewise, as a result of measuring the haze, the diffusion of transmitted light, the total transmitted light, the parallel of transmitted light, etc., using the haze measuring instrument under the same experimental conditions as the above case \textcircled{1}, the haze is 82.17%, the wavelength of the total transmitted light is 73.15 nm, the wavelength of the diffusion of transmitted light is 60.59 nm, and the wavelength of the parallel of transmitted light is 13.15 nm.

The moire sheet may be mounted alone on the backlight assembly as the optical sheet. However, in the embodiment, the optical sheet can be configured to further include at least one of the reflective sheet, the diffusion sheet, the brightness enhancement film (BEF), the lens pattern composite sheet, dual brightness enhancement film and the micro lens array (MLA) sheet together with the moire sheet. Preferably, the optical sheet is configured by adding the MLA sheet to the moire sheet. The reason is that the optical sheet further improves luminance, viewing angle, etc., as compared to the optical sheet configured of the moire sheet alone. More preferably, the optical sheet is configured by adding the brightness enhancement film sheet to the moire sheet. At this time, the optical sheet has the highest luminance and the widest viewing angle. This is due to the harmony action of the moire sheet having the maximum luminance and the brightness enhancement film having the maximum viewing angle.

When the optical sheet is configured to include at least one sheet of the reflective sheet, the diffusion sheet, Dual Brightness Enhancement Film, the brightness enhancement film (BEF), the lens pattern composite sheet, and the micro lens array (MLA) sheet and the moire sheet, the position of the sheet may not be specified. However, in the embodiment, it is most preferable that the sheet is stacked on the bottom surface of one pattern layer that forms the lowest layer among the pattern layers provided on the moire sheet. The reason is that the luminance and viewing angle are maximized.

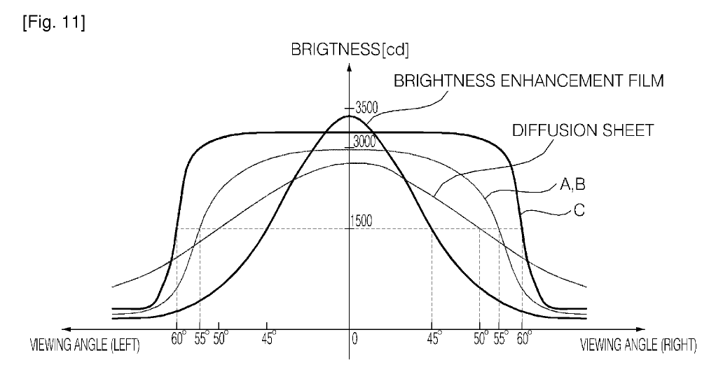

FIG. 10 is a comparative graph of luminance values for each optical sheet and FIG. 11 is a comparative graph of viewing angles for each optical sheet. In FIGS. 10 and 11, A indicates the optical sheet configured of the moire sheet alone. B indicates the optical sheet configured of the moire sheet and the MLA sheet and C indicates the optical sheet configured of the moire sheet and the brightness enhancement film. Referring to FIGS. 10 and 11, it can be confirmed that the optical sheet including the moire sheet further improves the luminance, the viewing angle, etc., as compared to the existing optical sheet.

As described above, the case where the moire sheet includes a single pattern layer or includes two pattern layers is described. When the moire sheet includes the single pattern layer, the first pattern array and the second pattern array are formed on both surfaces of the single pattern layer, respectively. On the other hand, when the moire sheet includes two pattern layers, the first pattern array and the second pattern array are formed on each pattern layer.

In the embodiment, it is possible to configure the composite sheet, on which the moire pattern is formed, by using at least two optical sheets including the single pattern layer. In other words, the composite sheet can be configured so that the moire pattern is generated by the overlapping between the first pattern array formed on the first optical sheet and the second pattern array formed on the second optical sheet. Meanwhile, at least one of the optical sheets provided on the composite sheet can include at least two pattern layers.

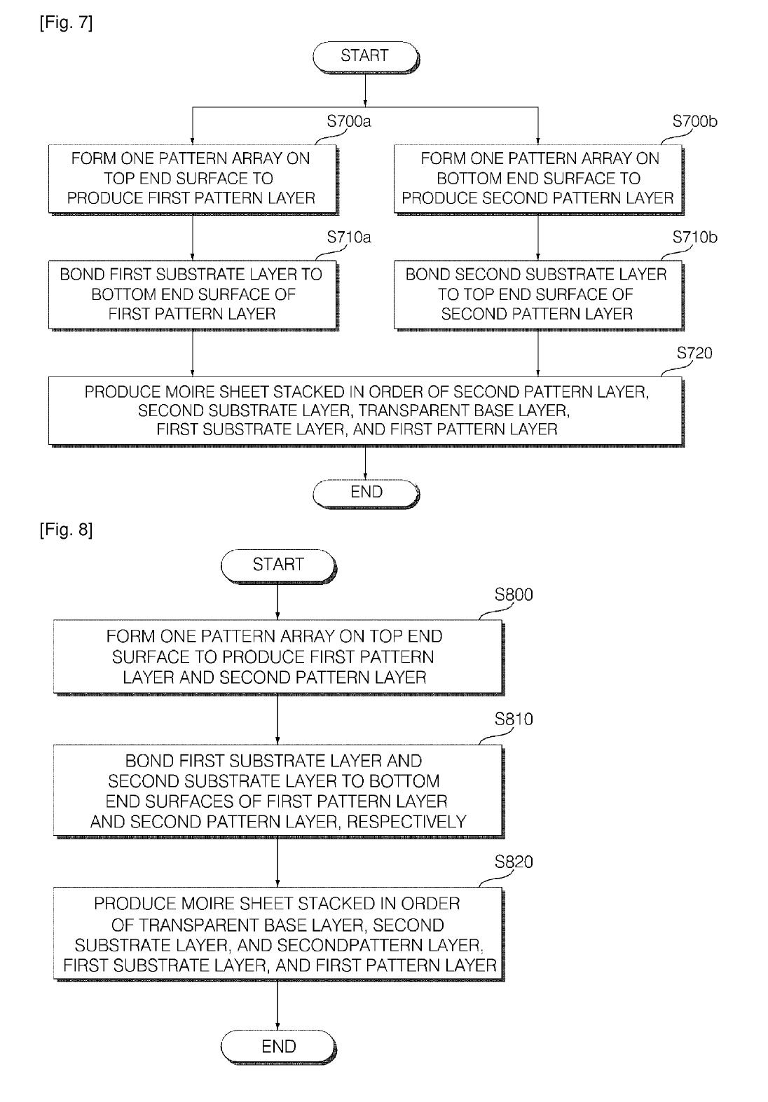

Next, a method for producing a moire sheet will be described. FIG. 7 is a flow chart for explaining a method for producing a moire sheet according to an exemplary embodiment of the present invention. FIG. 8 is a flow chart for explaining a method for producing a moire sheet according to an exemplary embodiment of the present invention.

FIG. 7 shows a method for producing a moire sheet when the transparent base layer is formed between two pattern layers. The moire sheet is the same as one shown in FIG. 1A and the following description will be described with reference to FIG. 7.

First, a first pattern layer having one pattern array formed on the top end surface thereof is produced by repetitively forming the specific patterns on a base including the specific adhesive component (S700a). On the other hand, a second pattern layer having one pattern array formed on the bottom end surface thereof is produced by repetitively forming the specific patterns beneath a base including the specific adhesive component (S700b). The same pattern arrays are generally formed on the produced first pattern layer and second pattern layer but different pattern arrays can be formed thereon. In addition, the base forming the first pattern layer and the base forming the second pattern layer generally include the same adhesive component but can include different adhesive components.

Thereafter, the base including the specific adhesive components is bonded to the bottom end surface of the first pattern layer (S710a). Thereby, the first substrate layer is formed at the bottom end of the first pattern layer. On the other hand, the base including the specific adhesive components is bonded to the top end surface of the second pattern layer (S710b). Likewise, the second substrate layer is formed at the top end of the second pattern layer. The base of the first substrate layer and the base of the second substrate layer include the same adhesive components but can include different adhesive components. In addition, the base of the first substrate layer generally includes the same adhesive component as any one of the base of the first pattern layer and the base of the second pattern layer, but can include the adhesive component different from two bases. The base of the second substrate layer may also be the same as the above-mentioned one.

Meanwhile, the first pattern layer and the first substrate layer can be simultaneously produced from the single substrate. This will be described in detail. First, the specific pattern array is formed on the base. Thereafter, in the base, a predetermined part including a part on which the pattern array is formed is established as the first pattern layer and the remaining parts are established as the first substrate layer. When the second pattern layer and the second substrate layer are also configured of a single base, they can be formed as described above.

Thereafter, the first pattern layer and the first substrate layer, which are integrated, are bonded to the top end surface of the transparent base layer. At this time, the bottom end surface of the first substrate layer is bonded to the top end surface of the transparent base layer. At the same time, the second pattern layer and the second substrate layer are bonded to the bottom end of the transparent base layer (S720). At this time, the top end surface of the second substrate layer is bonded to the bottom end surface of the transparent base layer. Meanwhile, as step S720, two bonding processes can be performed at different time. Meanwhile, after the first pattern layer and the second pattern layer are produced to have the same pattern array, the second pattern layer can be bonded beneath the first pattern layer in the state where the second pattern layer is tilted clockwise or counterclockwise with respect to the first pattern layer.

FIG. 8 shows a method for producing a moire sheet when the transparent base layer is not formed between two pattern layers. The moire sheet is the same as one shown in FIG. 1B and the following description will be described with reference to FIG. 8.

First, the first pattern layer having one pattern array formed on the upper end surface thereof is produced by repetitively forming the specific patterns on a base including the specific adhesive component. The second pattern layer is produced in the same method (S800). The same pattern arrays are generally formed on the produced first pattern layer and second pattern layer but different pattern arrays can be formed thereon. In addition, the base forming the first pattern layer and the base forming the second pattern layer generally include the same adhesive component but can include different adhesive components.

Thereafter, the base including the specific adhesive components is bonded to the bottom end surface of the first pattern layer. Thereby, the first substrate layer is formed at the bottom end of the first pattern layer. The second substrate layer is formed at the bottom end of the second pattern layer in the same method (S810). The base of the first substrate layer and the base of the second substrate layer include the same adhesive components but can include different adhesive components. In addition, the base of the first substrate layer generally includes the same adhesive component as any one of the base of the first pattern layer and the base of the second pattern layer, but can include the adhesive component different from two bases. The base of the second substrate layer may also be the same as the above-mentioned one.

Thereafter, the second pattern layer and the second substrate layer, which are integrated, and the first pattern layer and the substrate layer, which are integrated, are sequentially bonded to the upper end surface of the transparent base layer (S820). When step S820 is completed, the moire sheet on which the transparent base layer, the second substrate layer, the second pattern layer, the first substrate layer, the first pattern layer, etc., are sequentially stacked can be obtained.

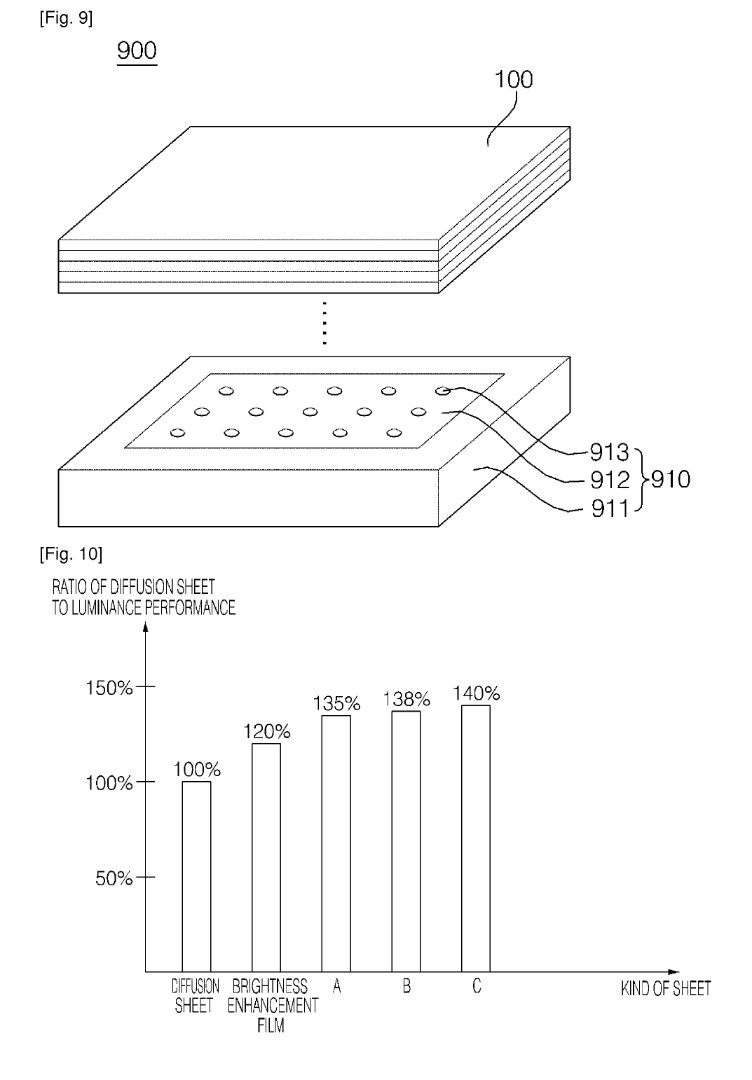

Next, the backlight assembly including the above-mentioned optical sheet will be described. The backlight assembly, which is an illumination device that is mounted on the panel rear of the display device such as the liquid crystal display (LCD), is the same concept as the backlight unit (BLU). FIG. 9 is a conceptual diagram schematically showing the backlight assembly according to the exemplary embodiment of the present invention. According to FIG. 9, a backlight assembly 900 according to the embodiment includes a light source unit 910 and the moire sheet 100. The following description will be described with reference to FIG. 9.

Currently, the liquid crystal display is largely interested in a market of a small-sized display as well as a large-sized display. The LCD is a display that generates light and shade and displays images by changing the alignment of the liquid crystal molecules by injecting liquid crystals between two thin glass plates when power is supplied. However, since the LCD is a light receiving/emitting device unlike a plasma display panel (PDP), an organic light emitting display (OLED), and a field emission display (FED), it cannot display images without having the back light source. Therefore, in the LCD, the backlight assembly, which is a light source capable of maintaining the entire display at uniform brightness, is necessarily needed.

The backlight assembly 900 includes a light source that irradiates light to the liquid crystal panel of the LCD. In the embodiment, the backlight assembly 900 includes at least two LEDs as the light source. Generally, the backlight assembly 900 using the LED depends on an edge type manner or a direct type manner. The edge type manner is a manner that is indirectly irradiated from the rear surface of the liquid crystal and the direct type manner is a manner that disposes a plurality of light sources on the rear and front of the liquid crystal panel and directly irradiates the rear surface of the liquid panel. Since the direct type manner directly irradiates light emitted from the light source to the rear surface of the liquid crystal panel without passing through a light guide plate, it can be used for a display that is high in the use efficiency of light and luminance. In the embodiment, the direct type backlight assembly 900 is proposed considering these respects.

Meanwhile, the display on which the backlight assembly 900 will be mounted is not limited to the LCD. If the display is a flat panel display requiring a separate light source, other devices can be used.

A light source unit 910 is supplied with a light source voltage from an inverter (not shown) to generate light and irradiates the generated light to the moire sheet 100. The light source unit 910 can be implemented by a base reflective plate 911, a circuit substrate 912 positioned on the base reflective plate 911, at least two LEDs 913 mounted on the circuit substrate 912, etc.

The LED 913 may be a combination of a white LED, a red (R) LDE, a green (G) LED, and a blue (B) LED. The LED 913 can be aligned on the circuit substrate 912 at a predetermined interval. However, in the embodiment, it is more preferable to align the LED 913 on the circuit substrate 912 at different intervals considering the tilt value between the pattern layers provided on the moire sheet 100. For example, when the patterns are densely provided within a predetermined range in the moire sheet 100, the number of LEDs 913, which illuminates the predetermined range, is smaller than a reference value. To the contrary, the number of LEDs 913 is larger than a reference value.

Meanwhile, the backlight assembly 900 may further include a light guide unit. At this time, the light guide unit, which uniformly illuminates the light irradiated from the light source unit 910 on the front surface of the moire sheet 100, can be made of transparent resin.

The backlight assembly 900 described above includes the moire sheet 100 that has at least two pattern layers having the tilt. The backlight assembly 900 can reduce the number of LEDs that irradiates light to a place where the patterns are densely provided, making it possible to reduce the production costs. The number of LEDs can be reduced to 300 or less from 700 to 1200 in the related art when using 40″ LCD TV as a reference. In addition, both the luminance and viewing angle, which are contrary to each other as described above, are improved, making it possible to provide high optical performance and the thickness of the optical film can be thinner through the moire sheet 100, making it possible to contribute to the slimness of the display.

Meanwhile, the backlight assembly 900 can be formed in the edge type manner. In this case, the backlight assembly may further include a light source, a light source wrapping unit, a light guide plate, etc., instead of the light source unit 910.

The light source performs a function that receives the light source voltage from the inverter to generate light and irradiates the generated light to the light guide plate. The light source can be configured including the fluorescent lamp. Examples of the fluorescent lamp may include a cold cathode fluorescent lamp (CCFL), a hot cathode fluorescent lamp (HCFL), an external electrode fluorescent lamp (EEFL), a light emitting diode (LED), etc.

The light source wrapping unit is a component that wraps the light source and totally reflects light emitted from the light source to perform the function of guiding light to the light guide plate.

The light guide plate performs a function of uniformly transferring light diffused from the light source to the front surface of the display. The light guide plate is formed of a reflector having reflectivity of 95% or more so that it is totally reflected without losing the irradiated light.

The spirit of the present invention has been just exemplified. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

### INDUSTRIAL APPLICABILITY

The present invention relates to the moire sheet and the backlight assembly having the same. The present invention has more excellent luminance and viewing angle as compared to the existing optical sheet through the moire sheet. Further, the present invention reduces the number of LED light sources, making it possible to reduce the production costs and makes the thickness of the optical film thin, making it possible to contribute to the slimness of the display. The present invention is very suitable for the current trend toward the slimness of the display, such that it is very excellent in view of the industrial/commercial aspects.

1. An optical sheet comprising:
a first pattern layer on which a first pattern array is formed; and
a second pattern layer on which a second pattern array generating a moire fringe by overlapping with the first pattern array is formed.

2. The optical sheet according to claim 1, wherein a first direction angle that one-dimensionally or two-dimensionally expresses an aligned direction of patterns forming the first pattern array and a second direction angle that one-dimensionally or two-dimensionally expresses an aligned direction of patterns forming the second pattern array are different from each other.

3. The optical sheet according to claim 1, wherein the first pattern array or the second pattern array is a set of patterns regularly aligned at each predetermined interval, and
the second pattern array includes at least one pattern that completely overlaps with one pattern of the first pattern array and at least one pattern that partly overlaps with one pattern of the first pattern array.

4. The optical sheet according to claim 2, wherein a difference between the first direction angle and the second direction angle exceeds 0° and is less than 90°.

5. The optical sheet according to claim 2, wherein the first pattern array includes the same number of patterns or a larger number of patterns as compared to the second pattern array.

6. The optical sheet according to claim 5, wherein the patterns included in the first pattern array or the pattern second array are formed in an intaglio form or an engraving form.

7. The optical sheet according to claim 1, further comprising a sheet layer having at least one of a reflective sheet, a diffusion sheet, a brightness enhancement film (BEF), a dual brightness enhancement film (DBEF), a composite sheet including a lens pattern sheet, and a micro lens array (MLA) sheet.

8. The optical sheet according to claim 1, wherein the patterns included in the first pattern array are different from the patterns included in the second pattern array.

9. The optical sheet according to claim 5, wherein the first pattern array or the second pattern array are formed on at least one surface of the first pattern layer or the second pattern layer.

10. The optical sheet according to claim 1, further comprising a third pattern layer formed with a third pattern array that overlaps with the first pattern array or the second pattern array.

11. The optical sheet according to claim 1, wherein the optical sheet includes transparent resin and further includes a transparent base layer that is formed beneath the first pattern layer.

12. The optical sheet according to claim 6, wherein the patterns included in the first pattern array or the second pattern array have a cutting surface of any one shape of a polygonal shape, a circular shape, and an oval shape.

13. The optical sheet according to claim 1, wherein when the first pattern array and the second pattern array include patterns in an intaglio form, an air layer having a previously defined thickness is formed between the first pattern layer and the second pattern layer.

14. The optical sheet according to claim 7, wherein the sheet layer is formed beneath the first pattern layer or the second pattern layer.

15. The optical sheet according to claim 11, wherein the transparent base layer includes at least one component of poly-ethylene terephthalate (PET) resin, poly-carbonate (PC) resin, poly-methyl methacrylate (PMMA) resin, and poly-styrene (PS) resin or the first pattern layer or the second pattern layer includes at least one of at least one thermosetting resin component selected from epoxy, urea, melamine, phenol, unsaturated polyester, and resorcinol, at least one thermoplastic resin component selected from acryl, urethane, vinyl acetate, polyvinylalcohol, polyvinyl chloride, polyvinyl acetal, saturated polyester, polyamide, and polyethylene, and UV curable adhesive component including epoxy resin or urethane resin.

16. An optical sheet according comprising:
a pattern layer having the first pattern array formed on one surface thereof and
the second pattern array, which generates the moire fringe by overlapping with the first pattern array, formed on the other surface thereof.

17. The optical sheet according to claim 16, wherein a first direction angle that one-dimensionally or two-dimensionally expresses an aligned direction of patterns forming the first pattern array and a second direction angle that one-dimensionally or two-dimensionally expresses an aligned direction of patterns forming the second pattern array are different from each other.

18. The optical sheet according to claim 16, wherein the first pattern array or the second pattern array is a set of patterns regularly aligned at each predetermined interval and the second pattern array includes at least one pattern that completely overlaps with one pattern of the first pattern array and at least one pattern that partly overlaps with one pattern of the first pattern array.

19. The optical sheet according to claim 16, further comprising a sheet layer having at least one of a reflective sheet, a diffusion sheet, a brightness enhancement film (BEF), a dual brightness enhancement film (DBEF), a composite sheet including a lens pattern sheet, and a micro lens array (MLA) sheet.

20. The optical sheet according to claim 16, wherein when the first pattern array and the second pattern array include patterns in an intaglio form, an air layer having a previously defined thickness is formed between the first pattern layer and the second pattern layer.

21. The optical sheet according to claim 19, wherein the sheet layer is formed beneath the pattern layer.

22. A composite sheet comprising:
a first optical sheet on which a first pattern array is formed; and
a second optical sheet on which a second pattern array generating a moire fringe by overlapping with the first pattern array is formed.

23. The composite sheet according to claim 22, wherein a first direction angle, which one-dimensionally or two-dimensionally expresses a direction in which the patterns forming the first pattern layer are aligned and a second direction angle, which one-dimensionally or two-dimensionally expresses a direction in which the patterns forming the second pattern layer are aligned, are different from each other.

24. The composite sheet according to claim 22, wherein the first pattern array or the second pattern array is a set of patterns regularly aligned at each predetermined interval, and
the second pattern array includes at least one pattern that completely overlaps with one pattern of the first pattern array and at least one pattern that partly overlaps with one pattern of the first pattern array.

25. The composite sheet according to claim 22, wherein the first optical sheet has the first pattern array formed on one surface thereof and a third pattern array, which overlaps with the first pattern array, formed on the other surface thereof.

26. A backlight assembly comprising:
any one sheet of an optical sheet that includes a first pattern layer on which a first pattern array is formed and a second pattern layer on which a second pattern array generating a moire fringe by overlapping with the first pattern array is formed, an optical sheet that includes a pattern layer having the first pattern array formed on one surface thereof and the second pattern array, which generates the moire fringe by overlapping with the first pattern array, formed on the other surface thereof, and a composite sheet that includes a first optical sheet on which the first pattern array is formed and a second optical sheet on which the second pattern array generating the moire fringe by overlapping with the first pattern array is formed; and
a light source unit that generates light and irradiates the generated light as incident light to the optical sheet.

27. The backlight assembly according to claim 26, wherein the light source unit includes at least two light emitting diodes (LEDs) and reduces the number of light emitting diodes that irradiate light to the unit area according to the density of the patterns per unit area of the optical sheet to control the number of light emitting diodes mounted on the light source unit.

28. The backlight assembly according to claim 26, wherein the backlight assembly is mounted on the display device that displays images using a back light source.

29. The backlight assembly according to claim 26, wherein the optical sheet includes a sheet layer having at least one of a reflective sheet, a diffusion sheet, a brightness enhancement film (BEF), a dual brightness enhancement film (DBEF), a composite sheet including a lens pattern sheet, and a micro lens array (MLA) sheet and further includes a sheet layer that is stacked beneath the second pattern layer.
